(19) United States
(12) Patent Application Publication
(10) Pub. No.: US 2025/0252092 A1
(43) Pub. Date: Aug. 7, 2025

(54) SYSTEMS, DEVICES, AND METHODS FOR INTERFACING WITH DATA REPOSITORIES USING OPTICAL CODES

(71) Applicant: CargoSense, Inc., Reston, VA (US)

(72) Inventors: Richard Allen Christopher KILMER, Centreville, VA (US); Darren Edward SULFRIDGE, Plano, TX (US); Christopher Lee SCHETTER, Chantilly, VA (US)

(73) Assignee: CargoSense, Inc., Reston, VA (US)

(21) Appl. No.: 19/042,328

(22) Filed: Jan. 31, 2025

Related U.S. Application Data
(60) Provisional application No. 63/548,613, filed on Feb. 1, 2024.

(51) Int. Cl. G06F 16/23; G06F 16/955; H04L 67/146

(52) U.S. Cl. CPC G06F 16/2329; G06F 16/9566; H04L 67/146

(57) ABSTRACT

An exemplary system receives data comprising one or more identifying values decoded from an optical code; transmits data indicating the one or more applications based on the one or more identifying values to a mobile device, wherein the one or more applications are respectively configured to enable access to one or more portions of the data repository based on respective permissions of the one or more applications within the data repository; receives information based on one or more inputs provided at a user interface of the mobile device, the user interface associated with a selected application of the one or more applications, wherein the information comprises an instruction instructing the server to update one or more keyed values in the data repository based on the one or more inputs; and updates the one or more keyed values in the data repository based on the received information.

### CROSS-REFERENCE TO RELATED APPLICATIONS

This application claims the benefit of U.S. Provisional Application No. 63/548,613, filed Feb. 1, 2024, the entire contents of which is incorporated herein by reference.

### FIELD

This disclosure relates generally to data repositories for collaborative supply chain management and more specifically to systems and methods for interfacing with data repositories using optical codes.

### BACKGROUND

Supply chain management presents a variety of challenges from production to inventory management and transportation and finally to sales and the end consumer. Key to effective supply chain management is effective collaboration between stakeholders, including suppliers, distributers, retailers, and consumers. Ineffective communication can lead to issues such as overstocking, unexpected product shortages, damaged goods, lost assets, etc., that may be preventable by enabling information parity between all relevant stakeholders in a supply chain.

### SUMMARY

Described herein are devices, systems, and methods for interfacing with data repositories configured to enable effective collaboration in supply chain management. The data repositories maintain sets of keyed values representing valuable information associated with assets, for instance, physical assets in a supply chain. Assets may be paired with optical codes that enable access to the data repositories storing such information. The systems and methods described herein enable individuals handling assets (e.g., shipping units, etc.) to interface with and collaborate with all parties involved, from manufacturers, to distributors, to logistics service providers to consignees and ultimately end consumers via the data repositories.

The data repositories may be configured to enable scoped access to underlying data associated with assets based on access privileges associated with different user identities, a hierarchical data structure of the data repositories, and other administrator configurable factors as described throughout. For example, applications accessible via the optical codes may enable users to access portions of a data repository based on the position within the hierarchical structure that the application is integrated. Similar hierarchy-based access privileges may be utilized to scope access for webhooks and API keys that enable systems access to data in the data repositories. Further, users may be granted access to different applications, with different access privileges, based on identifiers associated with the users (e.g., browser cookies, emails, phone numbers, etc.). Thus, the systems and methods herein provide a mechanism for supply chain collaboration that may afford various parties with different data insights and abilities to manipulate data associated with assets according to their respective role in the supply chain.

An exemplary system may be configured to enable access to data repositories associated with assets using applications accessible by scanning an optical code. A user may scan an optical code using their device, such as a mobile phone, and the device may transmit information decoded from the optical code to a remote server to obtain access to applications associated with that optical code. The device may receive data indicative of the respective applications from the remote server based on the transmitted decoded information and display visual indicators of those applications at a display of the device (e.g., in a browser window) for selection by a user. Selection of a visual indicator by the user may cause the device to display an interface associated with the application that enables the user to provide inputs that, when transmitted to the remote server, may cause the server to update one or more keyed values in the data repository associated with the optical code.

In some embodiments, the applications may be configured to enable access to one or more portions of a data repository based on respective permissions of the one or more applications within the data repository. The permissions may be based on a respective position of the application within a hierarchy of the data repository. The portions of the data repository may be referred to herein as namespaces, and the data repository may include, for instance, a parent namespace and a child (e.g., subsidiary) namespace. An application registered with the parent namespace may have access to data in the child namespace, but an application registered with the child namespace may not have access to data in the parent namespace. Such access privileges may provide administrators with more control over data associated with their respective assets. For example, administrators may desire suppliers to have access to some data associated with an asset while consumers may be granted access to different data associated with the same asset.

The data repositories described herein may be configured such that external services may access and/or modify the data in the data repositories. The external services may be coupled to the data repositories using webhooks for automatically obtaining updates when changes are made to the data in the data repository and/or API keys for accessing the data with read, write, and/or delete privileges. Like the applications, the webhooks and API keys may enable access to the repositories based on their position of integration within the hierarchy of the respective data repositories. Thus, the webhooks and API keys enable users to allow controlled access to data associated with assets in the supply chain for continuous collaborative management.

An exemplary method for updating a data repository stored at a remote server using one or more applications associated with an optical code comprises: detecting the optical code by a device comprising an optical detector and a display; decoding one or more identifying values encoded in the optical code and transmitting information including the one or more identifying values to the remote server; receiving data indicating the one or more applications from the remote server based on the one or more identifying values; displaying a visual indicator of the one or more applications at the display of the device based on the received data, wherein the one or more applications are respectively configured to enable access to one or more portions of the data repository based on respective permissions of the one or more applications within the data repository; detecting a user selection of a visual indicator of the one or more visual indicators associated with an application of the one or more applications; displaying a user interface associated with the application based on the user selection, wherein the user interface comprises a prompt for a user input for updating one or more keyed values in the data repository; receiving one or more inputs comprising information associated with the one or more keyed values to be updated via the user interface; and transmitting information based on the one or more inputs to the remote server, wherein the information comprises an instruction instructing the remote server to update one or more keyed values in the data repository based on the one or more inputs.

Optionally, the information transmitted to the server comprises identifying information associated with a user of the device, and wherein the received data indicating the one or more applications from the remote server is obtained by the remote server based on the identifying information associated with the user of the device.

Optionally, the identifying information associated with the user of the device comprises a browser cookie.

Optionally, the respective permissions of the one or more applications are based on a respective position of the one or more applications within a hierarchy of the data repository.

Optionally, the prompt comprises a request for an identifier from a user of the device, and wherein access to the application is restricted to one or more identifiers stored in association with the application in the data repository.

Optionally, the method includes receiving the identifier via the user interface in response to the prompt; transmitting the identifier to the remote server; comparing the identifier to the one or more identifiers stored in association with the application in the data repository; and determining whether to enable access to the application based on the comparison.

Optionally, the one or more identifiers comprise a domain name, a device identifier, a phone number, an email address, a name, or any combination thereof.

Optionally, each respective indication of the one or more applications associated in the data repository with the optical code is displayed in accordance with a determination that a predefined keyed value associated with the respective application of the one or more applications is stored in the data repository.

Optionally, the selected application is configured to enable registration of the optical code in the data repository with a unique identifier, and wherein the registration of the optical code in the data repository with the unique identifier restricts access to the application associated with the optical code to one or more users associated with the unique identifier.

Optionally, the one or more inputs comprise the unique identifier and wherein the instruction instructs the remote server to register the optical code associated with the application in the data repository with the unique identifier by associating the unique identifier with the optical code in the data repository.

Optionally, the one or more keyed values comprise: an event associated with an asset, an image of the asset, a measured characteristic of the asset, a handling instruction associated with the asset, an individual associated with the asset, a location of the asset, or any combination thereof.

Optionally, updating the one or more keyed values comprises: adding a keyed value to the data repository, deleting a keyed value from the data repository, modifying a keyed value in the data repository, or any combination thereof.

Optionally, the method includes transmitting, by the remote server, a notification to an external service based on the update to the one or more keyed values in the data repository, wherein the notification is transmitted to a URL associated with the external service stored in the data repository.

Optionally, the data repository is configured to enable one or more external services to read, write, and delete data stored in the one or more portions of the data repository using one or more application programming interface (API) keys.

Optionally, the device is a mobile phone.

An exemplary system for updating a data repository stored at a remote server using one or more applications associated with an optical code, the system comprising: one or more processors and memory storing one or more computer programs that include computer instructions, which when executed by the one or more processors, cause the system to: decode one or more identifying values encoded in the optical code detected by a device comprising an optical detector and a display; transmit information including the one or more identifying values to the remote server; receive data indicating the one or more applications from the remote server based on the one or more identifying values; cause display of a visual indicator of the one or more applications at the display of the device based on the received data, wherein the one or more applications are respectively configured to enable access to one or more portions of the data repository based on respective permissions of the one or more applications within the data repository; detect a user selection of a visual indicator of the one or more visual indicators associated with an application of the one or more applications; cause display of a user interface associated with the application based on the user selection, wherein the user interface comprises a prompt for a user input for updating one or more keyed values in the data repository; receive one or more inputs comprising information associated with the one or more keyed values to be updated via the user interface; and transmit information based on the one or more inputs to the remote server, wherein the information comprises an instruction instructing the remote server to update one or more keyed values in the data repository based on the one or more inputs.

An exemplary non-transitory computer readable storage medium storing instructions for updating a data repository stored at a remote server using one or more applications associated with an optical code, the instructions configured to be executed by a system, the system comprising one or more processors to cause the system to: decode one or more identifying values encoded in the optical code detected by a device comprising an optical detector and a display; transmit information including the one or more identifying values to the remote server; receive data indicating the one or more applications from the remote server based on the one or more identifying values; cause display of a visual indicator of the one or more applications at the display of the device based on the received data, wherein the one or more applications are respectively configured to enable access to one or more portions of the data repository based on respective permissions of the one or more applications within the data repository; detect a user selection of a visual indicator of the one or more visual indicators associated with an application of the one or more applications; cause display of a user interface associated with the application based on the user selection, wherein the user interface comprises a prompt for a user input for updating one or more keyed values in the data repository; receive one or more inputs comprising information associated with the one or more keyed values to be updated via the user interface; and transmit information based on the one or more inputs to the remote server, wherein the information comprises an instruction instructing the remote server to update one or more keyed values in the data repository based on the one or more inputs.

An exemplary system for updating a data repository using one or more applications associated with an optical code, the system comprising one or more processors and memory storing one or more computer programs that include computer instructions, which when executed by the one or more processors, cause the system to: at a server: receive data comprising one or more identifying values decoded from an optical code; compare the received data to one or more keyed values in the data repository to identify data indicating the one or more applications based on the received data; transmit the data indicating the one or more applications to a mobile device, wherein the one or more applications are respectively configured to enable access to one or more portions of the data repository based on respective permissions of the one or more applications within the data repository; receive information based on one or more inputs provided at a user interface of the mobile device, the user interface associated with a selected application of the one or more applications, wherein the information comprises an instruction instructing the server to update one or more keyed values in the data repository based on the one or more inputs; and update the one or more keyed values in the data repository based on the received information.

Optionally, updating the one or more keyed values comprises adding a new keyed value to the data repository as a new version of the updated keyed value and archiving the previous version of the keyed value in the data repository.

Optionally, the computer instructions, when executed by the one or more processors, cause the system to: transmit a notification to an external service based on the update to the one or more keyed values in the data repository.

Optionally, the notification comprises at least the updated keyed values.

An exemplary non-transitory computer readable storage medium storing instructions for updating a data repository using one or more applications associated with an optical code, the instructions configured to be executed by a system, the system comprising one or more processors to cause the system to: at a server: receive data comprising one or more identifying values decoded from an optical code; transmit data indicating the one or more applications based on the one or more identifying values to a mobile device, wherein the one or more applications are respectively configured to enable access to one or more portions of the data repository based on respective permissions of the one or more applications within the data repository; receive information based on one or more inputs provided at a user interface of the mobile device, the user interface associated with a selected application of the one or more applications, wherein the information comprises an instruction instructing the server to update one or more keyed values in the data repository based on the one or more inputs; and update the one or more keyed values in the data repository based on the received information.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary system for configuring and deploying data repositories associated with assets according to some embodiments.

FIG. 2 illustrates an exemplary user interface for creating profiles associated with a data repository according to some embodiments.

FIG. 3 illustrates an exemplary user interface for registering applications with a data repository according to some embodiments.

FIG. 4 illustrates an exemplary process for updating a data repository stored at a remote server using one or more applications associated with an optical code according to some embodiments.

FIG. 5 illustrates an exemplary process for updating a data repository stored at a remote server using one or more applications associated with an optical code according to some embodiments.

FIG. 6A illustrates an exemplary process for accessing a data repository associated with an asset via a lost and found application using an optical code according to some embodiments.

FIG. 6B illustrates an exemplary process for contacting an owner of an asset using an optical code associated with the asset according to some embodiments.

FIG. 7A illustrates an exemplary interface for inputting ownership information associated with an asset according to some embodiments.

FIG. 7B illustrates an exemplary interface for contacting an owner of an asset based on the ownership information provided via the interface of FIG. 8A according to some embodiments.

FIG. 8 illustrates an exemplary order packing list workflow according to some embodiments.

FIG. 9 illustrates an exemplary order workflow according to some embodiments.

FIG. 10 illustrates an exemplary delivery workflow according to some embodiments.

FIG. 11 illustrates an exemplary computing system according to some embodiments.

FIG. 12 illustrates an exemplary method for interacting with data repositories associated with optical codes provided on shipping documents according to some embodiments.

FIG. 13 illustrates an exemplary method for interacting with a data repository associated with a shipment via applications associated with an optical code provided on a document according to some embodiments.

### DETAILED DESCRIPTION

Described herein are devices, systems, and methods for interfacing with data repositories configured to enable effective collaboration in supply chain management. The data repositories may be configured to enable efficient upload, receipt, and storage of information associated with physical assets using optical code enabled network interfaces and may enable users to collaborate in supply chain management and obtain an up-to-date overview of an asset (e.g., shipping status, location, weight, or any other pertinent information added to the repository). The systems and methods described herein thus enable individuals handling assets (e.g., shipping units, etc.), or with access to optical codes associated with those assets, to interface with and collaborate with parties involved in the supply chain associated with the respective asset, from the manufacturers, to distributors, to logistics service providers to consignees and ultimately end consumers.

An exemplary system may be configured to enable access to data repositories associated with assets using applications accessible by scanning an optical code. A user may scan an optical code using their device, such as a mobile phone, and the device may decode information such as resource locators (e.g., URLs) from the optical code. The device may transmit data including information decoded from the optical code to a remote server to obtain access to applications associated with that optical code. The server may receive the transmitted data including one or more identifying values decoded from an optical code and/or identifiers associated with the device or its user. Based on the received data the server may retrieve and transmit data indicating the one or more applications to the device (e.g., using lookup information in the received data associated with applications stored in a data repository associated with the server).

The device may receive data indicative of the respective applications from the remote server and display visual indicators (e.g., selectable icons) of those applications at a display of the device (e.g., in a browser window) for selection by a user. Selection of a visual indicator by the user may cause the device to display an interface associated with the application that enables the user to provide inputs that, when transmitted to the server, may cause the server to update (e.g., add, delete, modify, or any combination thereof) one or more keyed values in the data repository associated with the optical code. The keyed values may represent any information associated with the asset, such as an event associated with an asset, an image of the asset, a measured characteristic of the asset, a handling instruction associated with the asset, an individual associated with the asset, a location of the asset, and so on. In some embodiments, the application, once selected, may cause the user's device to automatically measure and upload information for one or more keyed values (e.g., a location measurement from a GPS sensor of the user's device) without further user input.

The one or more applications are respectively configured to enable access to one or more portions of the data repository based on respective permissions of the one or more applications within the data repository. The permissions may be based on a respective position of the application within a hierarchy of the data repository. That is, the applications may be integrated (e.g., registered) with a specific portion of the data repository that falls within a hierarchy of a plurality of portions of the repository. The portions of the data repository may be referred to herein as namespaces, and the data repository may include, for instance, any number of “parent” namespace(s) and “child” (e.g., subsidiary) namespace(s). A namespace that is a parent to a first other namespace may be the child of a second other namespace, and similarly, a namespace that is a child to a first other namespace may be the parent of a second other namespace. An application registered with a parent namespace may have access to data in that parent's child namespace(s), but an application registered with a child namespace may not have access to data in that child's parent namespace(s). As noted above, such access privileges may provide administrators with more control over data associated with their respective assets. For example, administrators may desire suppliers to have access to some data associated with an asset while consumers may be granted access to different data associated with the same asset.

Additionally, or alternatively, access to different applications and/or different portions of the data repository itself may be provided to different users based on identifying information associated with the users and/or information stored in the data repository associated with an asset. For instance, a delivery driver may receive access to a first application associated with an asset, a supplier may receive access to a second application associated with an asset, and a consumer may receive access to a third application associated with the asset. In some embodiments, the server may return data indicating particular applications to the device that scanned the optical code based on identifying information associated with a user of the device (e.g., browser cookies, device identifiers, emails, names, phone numbers, or other identifying information) and/or the system may be configured to enable only users with allowed identifying information to open or access particular applications returned based on a given optical code. The system may be configured to recognize different users based on browser cookies, device identifiers, emails, names, phone numbers, or other identifying information. Based on the received identifying information associated with a user, the server may transmit an application tailored for use by that user (e.g., an application tailored for use by the end consumer or a supplier). Additionally, or alternatively, the system may be configured to prompt users for identifying information upon selection of an application returned by the server, and determine whether to grant a user access to the application based on an identifier input by the user via the device (e.g., through a user interface). The system may thus be configured to provide users with the most relevant information in the data repository and most useful interfaces for interacting with that data given their role (e.g., as supplier, consumer, etc.).

In some embodiments, the information in the data repositories may be accessed, added, updated, deleted, and so on using API keys and/or webhooks. The API keys and webhooks may be available to individuals, external services, software programs, etc. API keys may enable connected parties and services to read, write, and delete data in respective namespaces or data repository. Webhooks may be protocols that enable external services to be notified when changes to the data within an assigned namespace and/or repository occurs. For instance, a software program such as a virtual agent (including trained large language models) may be configured to communicate with users and update keyed values in the data repository based on user prompts using an API key. External services, such as stakeholders in a supply chain, may utilize webhooks to receive updates whenever changes are made in a data repository associated with an asset they have an interest in. As noted above, like the applications, the webhooks and API keys may enable access to the repositories based on their position of integration within the hierarchy of the respective data repositories. Thus, the webhooks and API keys enable users to allow controlled access to data associated with assets in the supply chain for continuous collaborative management. In some examples, a webhook or API key may be configured to receive updates whenever data in a given namespace is updated. Thus, systems connected to a namespace (e.g., a pallets namespace) may be notified via API key and/or webhook whenever data associated with any asset (e.g., pallet) having keyed values associated with that namespace is updated.

As used herein data repositories may refer to hierarchically organized data structures that enable scoped access to data associated with assets. In some examples, as used herein, a data repository may refer to a data warehouse or other data structure for organizing data associated with respective assets. In some examples, a large data repository may be organized into namespaces into which API keys, webhooks, and optical code enabled applications enable access to particular data associated with one or more assets within one or more namespaces of the data repository. In some examples, as used herein, a data repository may refer to a unique set of keyed values associated with an asset which may be stored within a larger data repository and/or as a discrete data repository. In some examples, an asset may be associated with a unique data repository, or a unique portion of a larger data repository (e.g., a unique set of keyed values), and the unique data repository or portion thereof may be respectively divided into and/or organized into a data structure formed by namespaces. In some examples, one or more unique data repositories associated with respective assets, or a unique portions of a larger data repository associated with respective assets, may be associated with and/or include one or more of the same namespaces.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

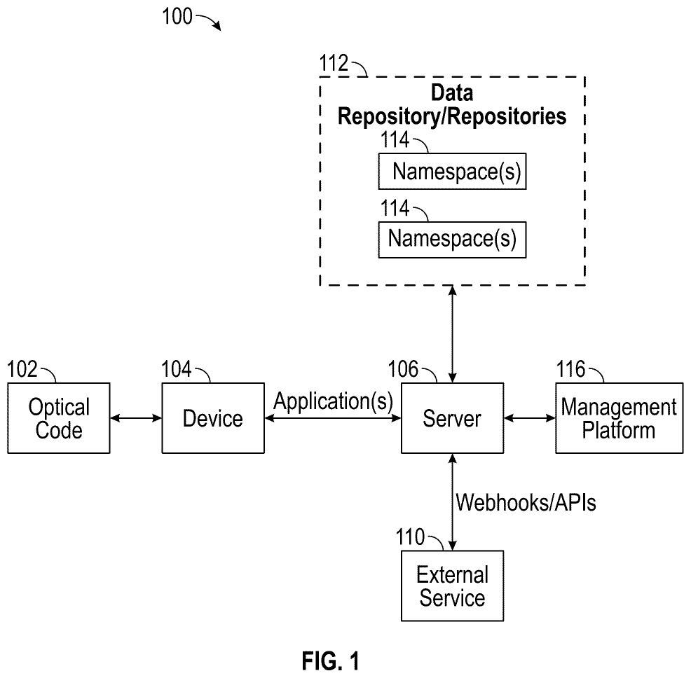

FIG. 1 illustrates an exemplary system 100 for configuring and deploying data repositories 112 associated with physical assets and accessing those data repositories 112 via applications (e.g., web applications) retrieved using optical codes 102 and/or via webhooks and API keys. System 100 may include a management platform 116 for enabling users to configure and the manage data repositories 112 associated with different assets. System 100 may generate and store digital label entries in the system (e.g., in the data repositories 112) and generate optical codes 102 that are uniquely associated with the label entries. A digital label entry may be a data object that represents a physical asset (or digital asset) in the system 100. The digital label entries may be stored in a data repository 112 and/or in any suitable storage system associated with server 106. That is, in some embodiments, a digital label entry may be stored as an entry in a database other than data repository 112. Each digital label entry may be identified in system 100 by a universally unique identifier (UUID).

The data repositories 112 may store keyed values associated with the physical assets. The data repositories 112 may enable any person who is handling a good/asset to interface with and collaborate with all parties involved, from manufacturers, to distributors, to logistics service provides to consignees and ultimately end consumers that also have access to the data repository (e.g., via an application, webhook, and/or API key). The data repositories 112 may be delineated into respective portions in a hierarchical manner. Each portion may be referred to herein as a namespace 114. The namespaces 114 may respectively form a hierarchical structure that holds keyed values in the data repository 112. Namespaces may be useful to isolate solutions, for instance, workflow tracking solutions, physical asset tracking solutions, etc., built for an organization and to group the webhooks, API Keys and applications built as part of those solutions.

The data in each of the namespaces 114 within a respective data repository 112 may be accessible using any of an application, a webhook, and/or an API Key. Webhooks may be protocols that enable external services 110, (e.g., individuals, stakeholders, businesses, software programs, etc.) to be notified when changes to the data within an assigned namespace 114 occurs, and API Keys enable external services 110 to be read, write and delete data in an assigned namespace 114. As noted above, the external services may be software programs such as digital agents (e.g., virtual assistants, trained machine learning models such as large language models (LLMs), etc.) that are communicatively coupled to the data repository. The virtual assistants may enable stakeholders to interact with the data repositories with an easy-to-use, natural language interface.

Applications may be web based single page applications or other applications that enable access to the data in an assigned namespace 114 of a data repository 112. As noted, the data in the data repositories may be accessible using an optical code 102 (e.g., by detecting the code by an optical scanner/camera of a device 104). More specifically, the applications for accessing/interfacing with a data repository 112 may be accessible via detection of an optical code 102. The optical code 102 may be a QR code, bar code, or other optical code configured to be detected by an electronic device such as device 104. The optical code may be physically located on or near the physical asset it represents and/or may be remotely associated with the asset. The optical code may encode authentication information, resource identification information (e.g., a URL, or other resource identifier), or other information to be decoded by the mobile device, as described further below.

System 100 can be configured to limit data access of the applications, webhooks, and/or API Keys. For instance, applications, webhooks, and/or API Keys may be allowed access to only a portion of data in a repository 112 based on the namespace 114 to which the application, webhook, and/or API is assigned/registered with. As an example, if an application is assigned to a namespace 114 lower in the hierarchy than a different namespace 114, it will only have access to data in the repository 112 that falls within the lower namespace. However, if an application is assigned to a namespace 114 higher in the hierarchy than a different namespace 114, the application will have access to data in both namespaces within the repository 112.

Management platform 116 of system 100 may provide interactive user interfaces to enable users to configure the data repositories 112, namespaces 114, applications, webhooks, API keys, optical codes 102, and various other aspects of system 100. In some embodiments, users may log into the management platform 116 under a respective organization, for instance, a employees of an organization may be provided with access to the platform via their respective organization. Those users may have access permissions to functionalities provided for managing data repositories 112 associated with that respective organization's assets. Users may have access to the platform 116 via more than one organization. Such users may switch organizations by selecting a dropdown menu of a graphical user interface of the management platform 116 and selecting another organization name from a list.

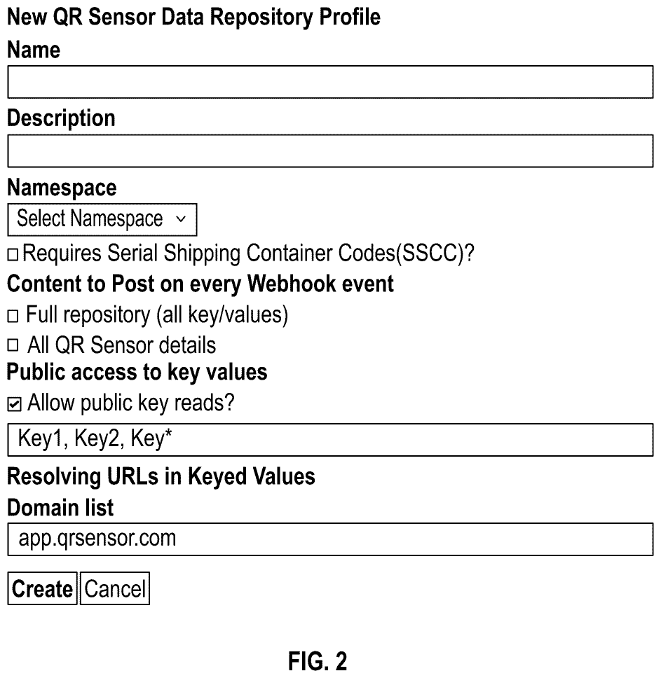

The data repositories 112 may respectively be associated with a profile created using the management platform 116, for instance, using the GUI illustrated in FIG. 2. Each profile may be associated with a particular asset or asset type (e.g., pallets, trucks, warehouses, etc.). The management platform 116 may enable users to name respective profiles, enter descriptions of the profiles, and select one or more namespaces 114 from the “select namespace” dropdown menu shown in FIG. 2 for the respective profile, which may impact data accessibility as noted above.

Management platform 116 may enable users to select whether all optical codes associated with a profile (and respective data repository 112) will receive their own, unique, Serial Shipping Container Code (SSCC), as shown in the user selectable check box of FIG. 2 labeled “Requires Serial Shopping Container Codes (SSSC)?”. SSCC is a GS1 standard for a logistics unit. It is a universally unique identifier and the value is guaranteed to be unique. SSCC codes may be helpful to produce both a QR Code and a 1D barcode.

Management platform 116 may enable users to select if webhook events (e.g., data transmissions to external service 110) include all data in a respective repository 112 and/or namespace 114 associated with a profile as well as all details associated with a respective repository 112 and/or asset for each event. For instance, a user can select “full repository” and/or “all QR sensor details” under “Content to post on every Webhook event” as shown in FIG. 2. Selection of these options may enable a stateless operation, as the full repository 112 and/or namespace 114 of data may be sent for every Key/Value update within the repository and all the details of the respective repository 112 and/or asset will also be sent.

Similarly, management platform 116 may enable users to allow public access to data within a repository 112 as shown in the “allow public access to key reads” check box in FIG. 2. Users can configure the keys within a repository 112 to supply (e.g., as a comma-separated list) for the public JSON view of data under a respective profile when accessed by an external HTTP request. Public JSON data may require no authentication, simply the UUID/Key pair which is the URL in the optical codes 102 associated with a repository 112 with the addition of “json” to that URL.

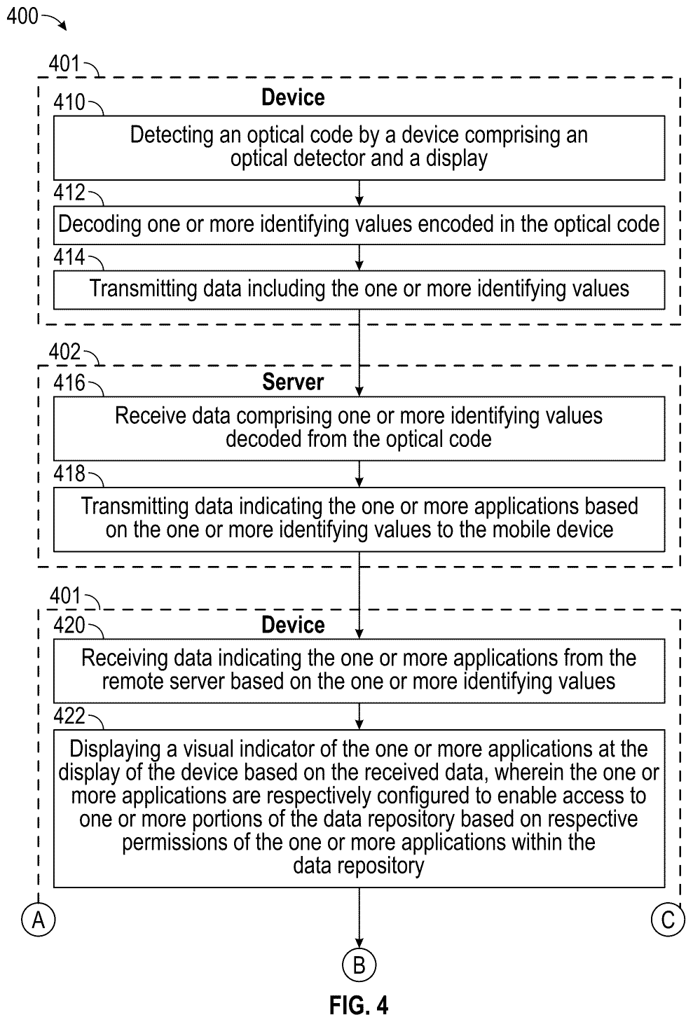

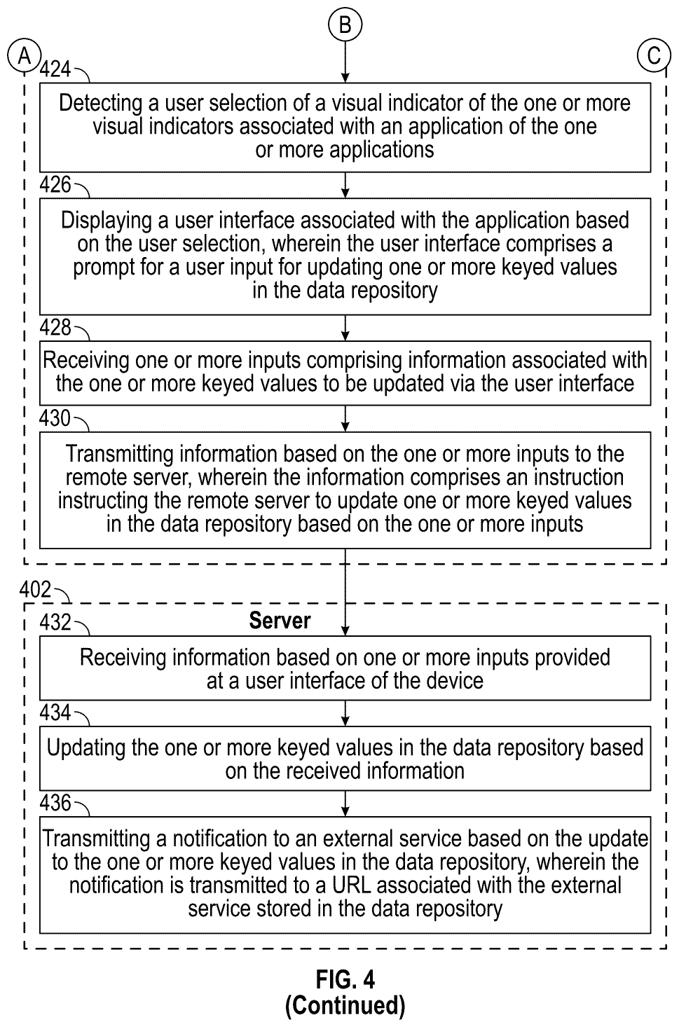

Management platform 116 may enable users to configure the domains that URLs in keyed values will resolve from. For instance, when an application associated with a data repository 112 needs to reference another data repository 112 (e.g., via scanning an optical code associated with that data repository), it stores the URL of the scanned optical code as a URL that needs to be resolved by the qrsensor.com service, which as shown in FIG. 4 is the domain provided in the domain list. This domain list allows users to extend the types of trusted URL/domains.

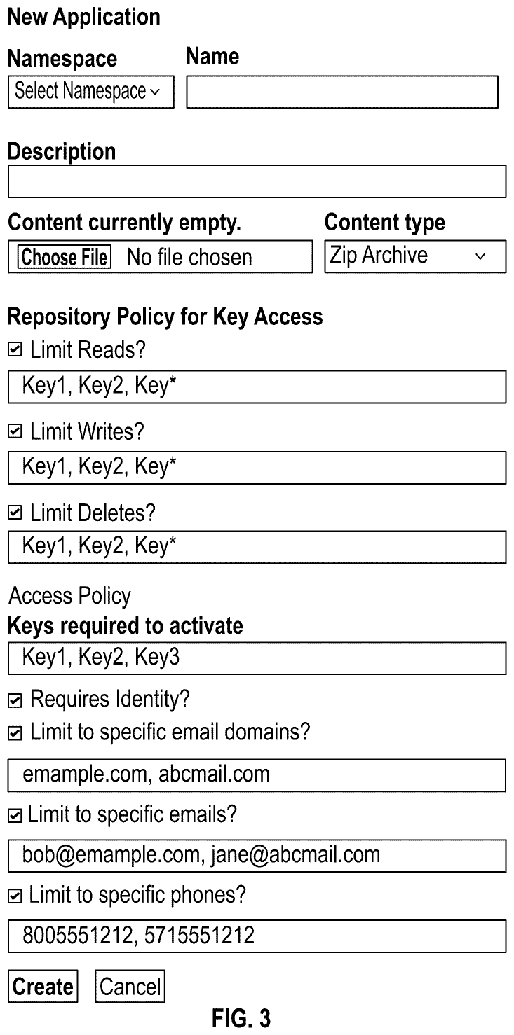

Management platform 116 may also enable users to generate any number of optical codes associated with respective data repositories 112 (and corresponding assets) and to configure applications accessible via those optical codes. The applications may be developed/configured according to standard application development methods (e.g., an application may be a set of files that include html, CSS, images and JavaScript) using the graphical user interface (GUI) illustrated in FIG. 3. When registering an application via management platform 116, users may select a namespace 114 for the application and enter a name and description of the application. Users may also set a repository policy for the application, which may define the keys that an application can read, write or delete, as shown in the “Repository Policy for Key Access” section of the GUI shown in FIG. 3. If the selectable boxes shown in the Repository Policy for Key Access section of FIG. 3 are not checked, an application may be able to read or modify any key.

Additionally, the GUI of FIG. 3 may enable users to define an access policy using management platform 116 for using respective applications. The access policy may define which identities (e.g., unique browser identifiers, device identifiers, emails, phones, email domains, names, etc.) can access a respective application and which keys need to be present in a data repository 112 for the application to be available (e.g., to any user). Users of management platform 116 can configure which keys are required to have a value in the Key/Value repository in order to activate an application (make available to use) as shown in the “Keys required to activate” section of the GUI shown in FIG. 3. The keys may be entered as a list, e.g., a comma-separated list. Similarly, allowed identities can be entered as comma separated lists if the “requires identity” box (or similar identity type boxes) are checked.

Finally, management platform 116 may enable users to configure the webhooks that enable external services to receive notifications when data in respective namespaces 114/repositories 112 is changed and/or the API keys that enable users to read, write, and delete data in respective namespaces 114/repositories 112. Users may assign the webhooks and API keys to respective namespace(s) 114 to define the data accessible via the given webhooks and API keys using the management platform 116.

FIG. 4 illustrates an exemplary process 400 for updating a data repository stored at a remote server using one or more applications associated with an optical code, according to some embodiments. Process 400 is performed, for example, using one or more electronic devices implementing a software platform. In some examples, process 400 is performed using one or more electronic devices. In some embodiments, process 400 is performed using a client-server system, and the blocks of process 400 are divided up in any manner between the server and one or more client devices. Thus, while portions of process 400 are described herein as being performed by particular devices, it will be appreciated that process 400 is not so limited. In process 400, some blocks are, optionally, combined, the order of some blocks is, optionally, changed, and some blocks are, optionally, omitted. In some examples, additional steps may be performed in combination with the process 400. Accordingly, the operations as illustrated (and described in greater detail below) are exemplary by nature and, as such, should not be viewed as limiting.

At block 410, process 400 includes detecting an optical code by a device that includes an optical detector and a display. The optical code may be associated with an asset, (e.g., a physical asset and/or a digital asset). Exemplary physical assets may include consumer goods, shipped items, facility equipment (e.g., machinery, climate control systems, etc.), and so on. Exemplary digital assets may include NFTs, audiobooks, articles, videos, and so on. It should be understood that the aforementioned physical and digital assets are exemplary and not mean to be limiting. The optical code may be physically located on or near the asset and/or may be located/positioned away from the asset (e.g., positioned at any distance away from an asset, such as in a user manual located away from the asset). For instance, in some embodiments, a digital representation of the optical code may be displayed at a display of an electronic device that may or may not be affixed to the asset. In some embodiments, a physical representation (e.g., printout) of the optical code may be taped, glued, fastened, or otherwise affixed to the asset. In some embodiments, the optical code may be located proximally to the asset but not physically located on the asset. For instance, the optical code may be affixed to a wall adjacent to a loading dock door (e.g., where the asset is the loading dock door), or it may be affixed adjacent to a control panel (e.g., where the asset is a security system, climate control system, and so on). In some embodiments, the location of the optical code may be entirely unrelated to the location of the asset. For instance, the optical code may be provided in a user manual, email, or other physical or electronic document associated with the asset, such that the optical code can be detected by device at any distance away from the asset. The optical code may encode authentication information, resource identification information (e.g., a URL, or other resource identifier), or other information to be decoded by the mobile device, as described further below.

At block 412, the device that detected the optical code may decode information encoded in the optical code (e.g., using one or more processors). The decoded information may include an authentication portion and a lookup portion. The authentication portion may include authentication information (e.g., one or more authentication codes). The authentication portion may be configured to authorize a communication link between the device and the server and/or a data repository accessible via the server. The lookup portion may include one or more resource identifiers, for instance, one or more Uniform Resource Identifiers (URI), Universal Resource Names (URN), Universal Resource Locators (URL), and/or other identifier information. The lookup portion may enable the device to locate and access one or more local or remote network resources, for instance by opening an internet-accessible webpage in a web browser to communicate with a server. In some embodiments, the lookup portion may enable the device to read from and/or write data to a data repository associated with the optical code, for instance, by enabling access to one or more applications associated with the data repository that are configured to read from and/or write data to the data repository. Accordingly, the decoded information may include one or more identifying values associated with one or more applications, which the device may decode and transmit to a server based on the lookup information as described at block 414 below.

At block 414, the device may transmit data including the one or more identifying values decoded from the optical code to a remote server (e.g., a server identified based on the lookup information encoded in the optical code). As noted above, the identifying values may be indicative of one or more applications associated with the optical code that the server may provide the device access to. The data transmitted by the device may also include identifying information associated with the device, such as a browser cookie, device identifier, or other identifying information. Identities may be associated with a browser cookie based on a user provided contact (e.g., email, phone number, etc.). A random number may be transmitted to the provided contact (e.g., email, phone number, etc.). The user can then enter the random number into the device to verify their identity. The identity may be stored in the cookie for use in scoped access to the data repositories described herein.

At block 416, the server may receive the data including one or more identifying values decoded from the optical code. The server may retrieve data indicating one or more applications associated with the one or more identifying values from a data repository. The data indicating the one or more applications may include additional lookup information (e.g., a URL to a web application) that may enable the device (upon receipt of the information) to access the one or more applications, as described below. At block 418, the server may transmit the data indicating the one or more applications to the device. For instance, the server may transmit lookup information for all applications that are associated with the optical code such that a user may access the repository using one of the applications associated with the code that they have permissions for, as described below.

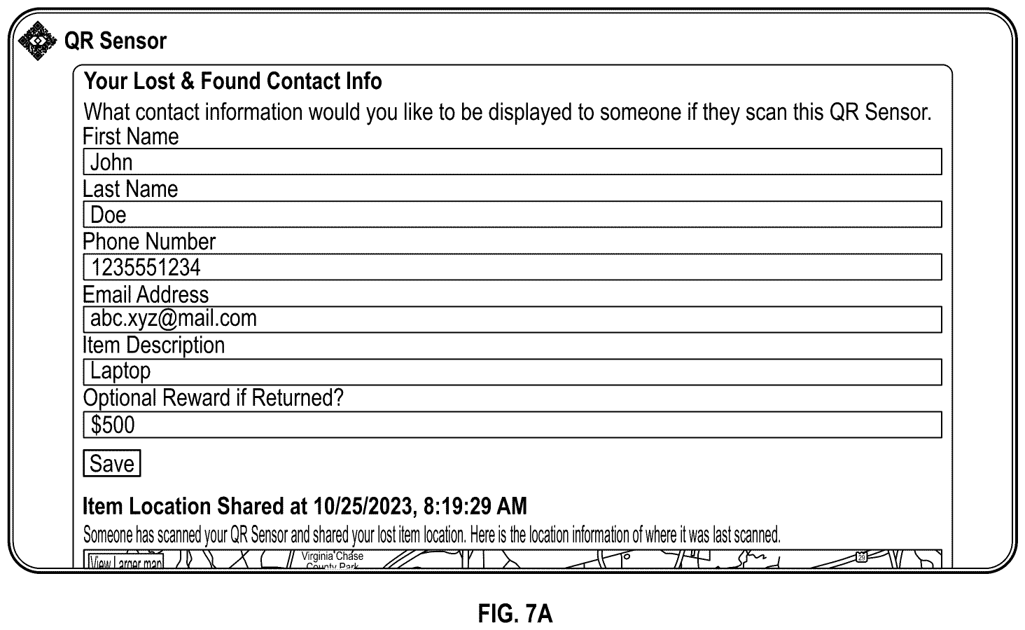

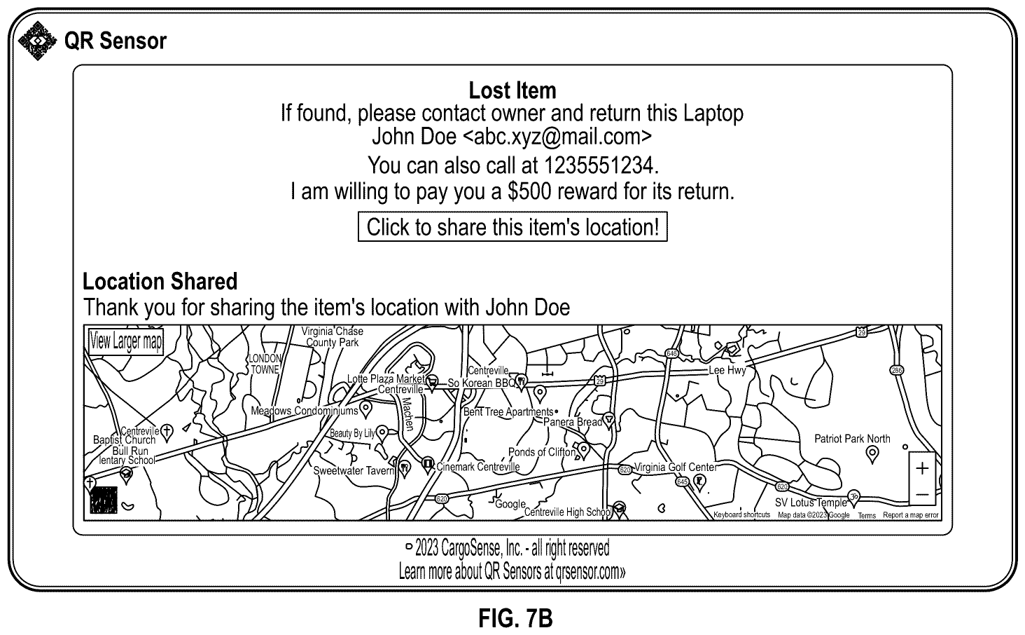

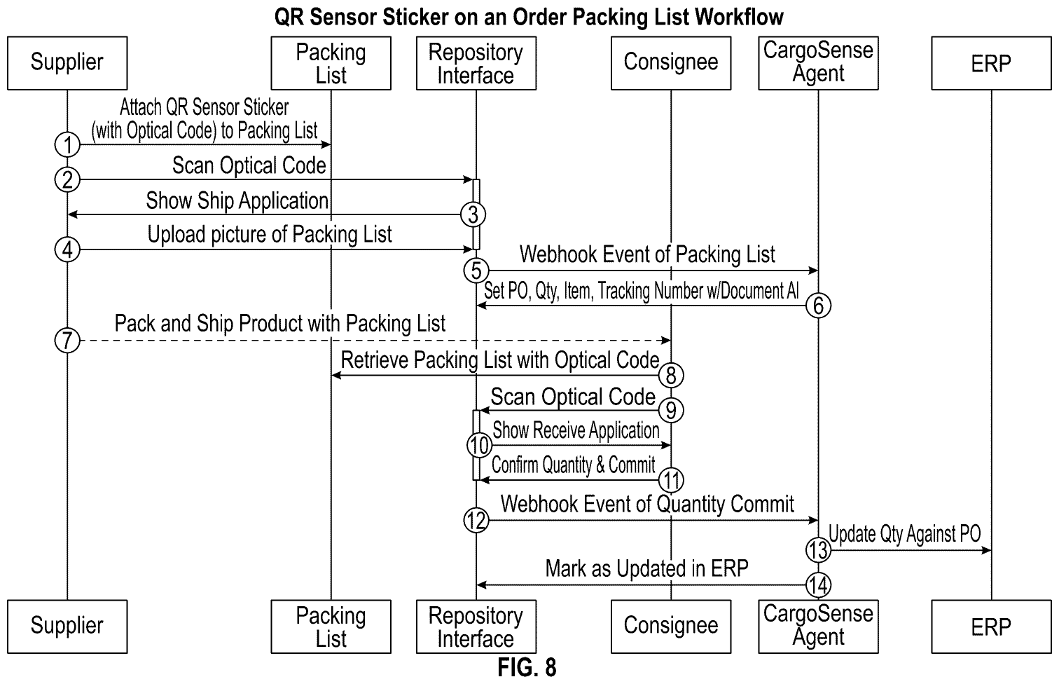

In some embodiments, the server transmits data indicating one or more applications associated with the optical code in accordance with a determination that a predefined keyed value associated with the respective application of the one or more applications is stored in the data repository. That is, the server may or may not return all applications associated with an optical code depending on information stored in the repository. More generally, the data indicating the applications may be transmitted in accordance with the user configurable access policy described above with reference to FIG. 1. The access policy may define which identities can access a respective application and/or which keys need to have values present in the data repository for the application to be available (e.g., for the server to return any indication of the application in the first place). As an example, the server may only transmit data indicating applications which have been activated, for instance, in accordance with a user registering their identity with the optical code associated with the application in the data repository (e.g., as described with reference to the Lost and Found embodiment described below with reference to FIGS. 7A-8B). The server my be configured to compare an identity such as a browser cookie included in the data transmitted to the server from the device to data in the repository to determine which data indicating one or more applications, if any, to transmit back to the device.

At block 420, the device may receive the data indicating the one or more applications from the remote server and utilize the data indicating the one or more applications to enable access (e.g., for a user of the device) to the one or more applications. For instance, at block 422, a visual indicator of the one or more applications may be displayed at a display of the device based on the received data. Depending on access policy configurations associated with the respective applications (e.g., configured as described above using management platform 116) each respective visual indicator of the one or more applications associated in the data repository with the optical code may be displayed in accordance with a determination that a predefined keyed value associated with the respective application of the one or more applications is stored in the data repository.

The visual indicators of the one or more applications may be user selectable, and when selected, may enable access to an application associated with the visual indicator. Specifically, selection of a visual indicator may cause the device to access a resource locator associated with the visual indicator included in the data transmitted from the server to the device. As an example, an application may be a web or mobile application, and the visual indicators may be associated with respective URLs to which the device navigates upon selection of one of the visual indicators. In some embodiments, the one or more applications may be web-based SPAs (single page applications) that provide access to the data in the data repository through a web browser based on the process described above following detection of the optical code. An application may be a single HTML file, or a set of files that include HTML, CSS, images and JavaScript.

In some embodiments, the one or more applications may be respectively configured to enable access to one or more portions of the data repository based on respective permissions of the one or more applications within the data repository. The respective permissions of the one or more applications may be based on a respective position of the one or more applications within a hierarchy of the data repository. That is, the data repository may include a hierarchical structure and the one or more applications may each be integrated with the data repository at a respective level of that hierarchy. Their respective position within the hierarchy of the data repository may determine whether the respective application is accessible via a given optical code and/or whether the application has access to modify data in a respective portion of the data repository. Portions of the data repository may be referred to herein as namespaces, as described above with reference to FIG. 1.

As a simple example to illustrate the repository hierarchy into which the applications are integrated, the repository can be thought of as a set of warehouses. The portions of the repository making up the hierarchy of the data structure may be referred to as namespaces herein. The root namespace (e.g., root portion) of the repository may be denoted “/.” A child or subsidiary namespace of the repository may be denoted “/warehouses.” Based on, for instance, the types of things in the warehouses, the repository may further be delineated into additional child (e.g., subsidiary) namespaces such as: “/warehouses/pallets,” “/warehouses/rack-positions,” and/or “/warehouses/bay-doors.” Access to the data under each namespace of the repository (e.g., each portion of the repository within the hierarchy) is limited to that namespace and its child namespaces. In the above example, anything (e.g., applications, webhooks, API keys, etc.) with access to the namespace/warehouses would have access to the data in/warehouse/pallets and/warehouses/rack-positions. However, applications (as well as webhooks and API keys) that have access data only in/namespaces/pallets would not have access to/warehouses/rack-positions.

At block 424, a user selection of a visual indicator associated with an application may be detected, and at block 426, a user interface associated with the application based on the user selection may be displayed at a display of the device. The user interface may enable a user of the device to interact with (e.g., add, delete, modify) data in the data repository. The user interface may include a prompt for a user input for updating one or more keyed values in the data repository. The prompt may include one or more requests for a variety of information, as described below.

In some embodiments, the prompt may include a request for an identifier from a user of the device, and access to the application may be restricted to one or more identifiers stored in association with the application in the data repository. The one or more identifiers may include a domain name, a device identifier, a phone number, an email address, a name, or any combination thereof. A user may enter an identifier, and upon receipt of the identifier, via the user interface in response to the prompt, the device may transmit the identifier to the server. The server may compare the identifier to the one or more values (e.g., predefined allowed identifiers) stored in association with the application in the data repository and determine whether to enable access to the application based on the comparison. In some embodiments, the server may store the identifier entered by the user in association with the application in the data repository to register the application and/or optical code with the user that entered the identifier, for instance, as described below at block 228. In some embodiments, instead of, or in addition to prompting a user for an identifier, the identifier may be obtained based on a browser cookie associated with the user attempting to access the application.

In some embodiments, the prompt may include a request for information about an asset. For instance, the prompt may request information about an event (e.g., a shipping event such as “shipped,” “in transit,” “delivered,” etc.) associated with an asset, an identifier of an asset, an image of the asset, a measured characteristic (e.g., temperature, weight, etc.) of the asset, a handling instruction (e.g., delivery deadline, temperature requirements, instructions to issue periodic shipment status updates, etc.) associated with the asset, an individual associated with the asset, a location of the asset, documentation (e.g., order forms, payment information, etc.) associated with an asset, shipping status (e.g., delivered, in transit, order received, etc.), order quantity verified, damage to an asset, rejection of a delivery, or any combination thereof.

At block 428, one or more inputs including information associated with the one or more keyed values to be updated may be received by the device via the user interface. The one or more keyed values updated based on the inputs may be associated with any information associated with the asset, including the identifiers associated with an asset, events associated with the asset, images of the asset, measured characteristics of the asset, handling instructions associated with the asset, individuals associated with the asset, locations of the asset, the state of the asset (e.g., full or empty, frozen or thawed, validated or unvalidated, etc.), the use of an asset for a task (e.g., removing something from a pallet, using a tool to perform an action, etc.), process exceptions that are in effect for an asset (e.g., the asset is not stored at the proper temperature, etc.), steps completed in a process associated with the asset, relation of the asset to other assets, or any combination thereof.

As an example, the selected application may be configured to enable registration of the optical code in the data repository with a unique identifier. Registration of the optical code in the data repository with the unique identifier may restrict access to the application associated with the optical code to one or more users associated with the unique identifier. The one or more inputs may include the unique identifier and the server may be instructed to register the optical code associated with the application in the data repository with the unique identifier by associating the unique identifier with the optical code in the data repository.

As another example, a selected application may be configured to capture process information associated with an asset. For instance, assets such as tractor trailers may need to be cleaned between shipments of different types of goods. It can be difficult to verify that such cleaning has been completed. An application accessible via an optical code provided at the trailer (e.g., inside the trailer, on the door, on one or more documents in the trailer) may be retrieved at a device by scanning the optical code, and a user may select an affordance associated with an interface of the application to start the cleaning process. The application may prompt a user for information, such as a photo of the license plate or other identifier of the trailer to be cleaned to validate that the user is accessing a code associated with the appropriate asset. The application may prompt the user for additional or different information, including but not limited to their own identifying information, credentials, contact information, a photograph of the uncleaned trailer, and so on. The information may be transmitted to and stored in a data repository associated with the optical code (e.g., as described in blocks 430-434 below). After cleaning the trailer, the user may sign a document associated with the optical code (e.g., the optical code may be printed on a signature sheet for tracking the cleaning process of the trailer). The user may then upload a photograph of the document with the signature and/or a photograph of the cleaned trailer to the data repository using the application. The user may then attach the signed document to the trailer (e.g., to the door, inside wall, etc.) for reference by others (e.g., inspectors), who may scan the optical code to obtain access to the data (e.g., photographs of the trailer before and after cleaning) to verify that the trailer was cleaned.

At block 430, the device may transmit information based on the one or more inputs to the server. The information may include an instruction instructing the remote server to update one or more keyed values in the data repository based on the one or more inputs. At block 432, the server may receive the information transmitted based on one or more inputs provided at a user interface of the device, and at block 434, the server may update the one or more keyed values in the data repository based on the received information. Updating the one or more keyed values may include adding a keyed value to the data repository, deleting a keyed value from the data repository, modifying a keyed value in the data repository, or any combination thereof. The server may also archive any updated keyed values within the data repository and/or within a separate database.

At block 436, the server may transmit a notification to an external service based on the update to the one or more keyed values in the data repository. The notification may be transmitted to a URL associated with the external service stored in the data repository. The notifications may be transmitted to the external service(s) using webhooks. Webhooks may be configured by associating callback resource locators (e.g., URLs) with one or more namespaces in the repository (e.g., portions of the repository hierarchy). The resource locator is the endpoint on an external service that may receive webhook data. Webhooks may be notified within seconds of changes to the data in a repository or namespace thereof. Webhook notifications may be sent whenever an optical code and corresponding data repository are activated, whenever a data repository (or portion thereof) associated with an optical code is archived, whenever a keyed value of a repository is created, modified, or deleted, etc. As described with reference to FIG. 1, webhooks can be configured using the management platform 116 and may be configured to receive all data in a respective namespace and/or repository whenever a keyed value is updated. The external services may also be connected to repositories and/or respective namespaces thereof using API keys. API Keys enable external services to be read, write and delete data in the repositories. As with the applications and webhooks, the namespace to which an API key is registered may limit the data that an API Key can access.

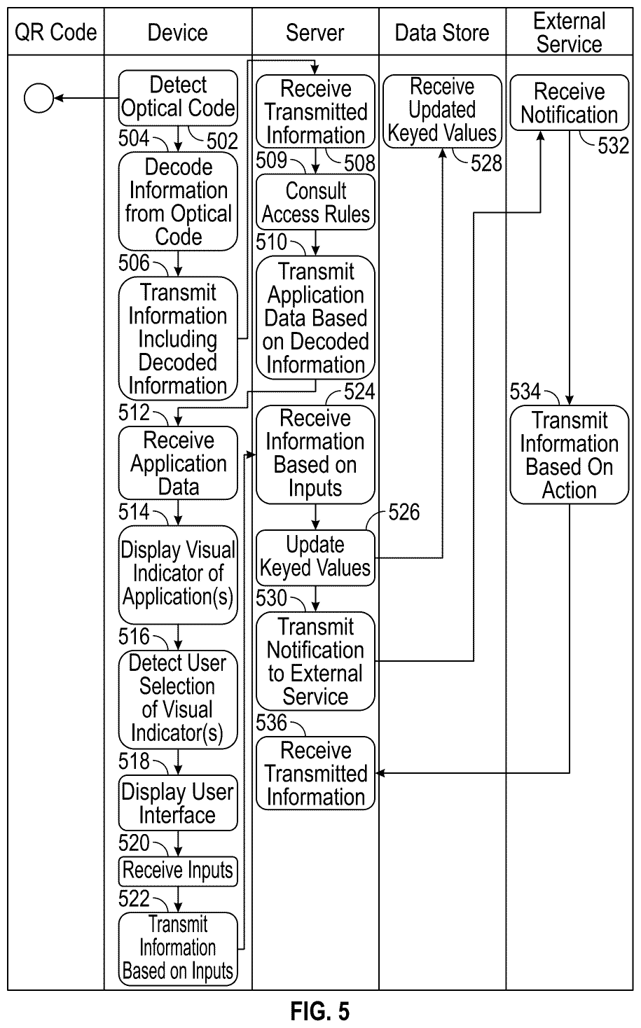

FIG. 5 illustrates an exemplary process for updating a data repository stored at a remote server using one or more applications associated with an optical code. Process 500 may include any of the features described above with reference to process 400 of FIG. 4. Process 500 is performed, for example, using one or more electronic devices implementing a software platform. In some examples, process 500 is performed using one or more electronic devices. In some embodiments, process 500 is performed using a client-server system, and the blocks of process 500 are divided up in any manner between the server and one or more client devices. Thus, while portions of process 500 are described herein as being performed by particular devices, it will be appreciated that process 500 is not so limited. In process 500, some blocks are, optionally, combined, the order of some blocks is, optionally, changed, and some blocks are, optionally, omitted. In some examples, additional steps may be performed in combination with the process 300. Accordingly, the operations as illustrated (and described in greater detail below) are exemplary by nature and, as such, should not be viewed as limiting.

At block 502, a device may detect an optical code. The optical code may include any of the characteristics described above with reference to FIGS. 1 and 4. At block 504, the device may decode information from the optical code. At block 506, the device may transmit information including the decoded information to a server. The information may include identifying information associated with the device and one or more identifying values decoded from the optical code. At block 508, the server may receive the transmitted information and process the transmitted information to retrieve data from a data repository. The retrieved information may include application data obtained based on the decoded information and/or identifying information associated with the device. The received information may additionally include identifying information associated with the device that scanned the optical code (e.g., a device identifier) and/or identifying information associated with a user of the device (e.g., a browser cookie, email, and so on).

At block 509, the server may consult access privilege rules (e.g., compare received identifying information decoded from the optical code and/or associated with the device and/or user to determine which data (e.g., applications) to return to the device). Different optical codes may be associated with a variety of different applications, and different devices and users may be provided with access privileges to those different applications. Information regarding which applications are accessible via a given optical code and/or which devices/users should be provided data indicative of respective applications may be stored in the data repositories (or other data storage mechanism) for consultation by the server upon receipt of an access request from a device (e.g., when an optical code is scanned by the device, resulting in a transmission to the server).

At block 510, the server may transmit the application data retrieved based on the decoded information and/or identifying information associated with the device back to the device. At block 512, device may receive the application data and, at block 514, the device may display one or more visual indicators of one or more applications based on the received application data. At block 516, the device may detect a user selection of one of the visual indicators and display a user interface associated with the selected indicator (e.g., a user interface of the application associated with the selected indicator) at block 518. The device may receive one or more inputs from the user via the user interface at block 520 and may transmit information back to the server based on the received inputs at block 522. At block 524, the server may receive the transmitted information based on the inputs received at the device and may update (e.g., add, delete, or modify) one or more keyed values of the data repository based on the transmitted information at block 526. At block 528, a data store that includes the data repository may receive the updates to the one or more keyed values.

At block 530, the server may transmit a notification associated with the updated keyed values to an external service. The external service may receive the notification at block 532, and may transmit information back to the server at block 534. The transmitted information may include additional updates to keyed values, requests for more information, etc. At block 536, the server may receive the transmitted information from the external service. The server may take a variety of actions based on the received information. For instance, the server may push notifications out to the device, may update one or more keyed values of the data repository, push an additional notification out to the external service, etc.

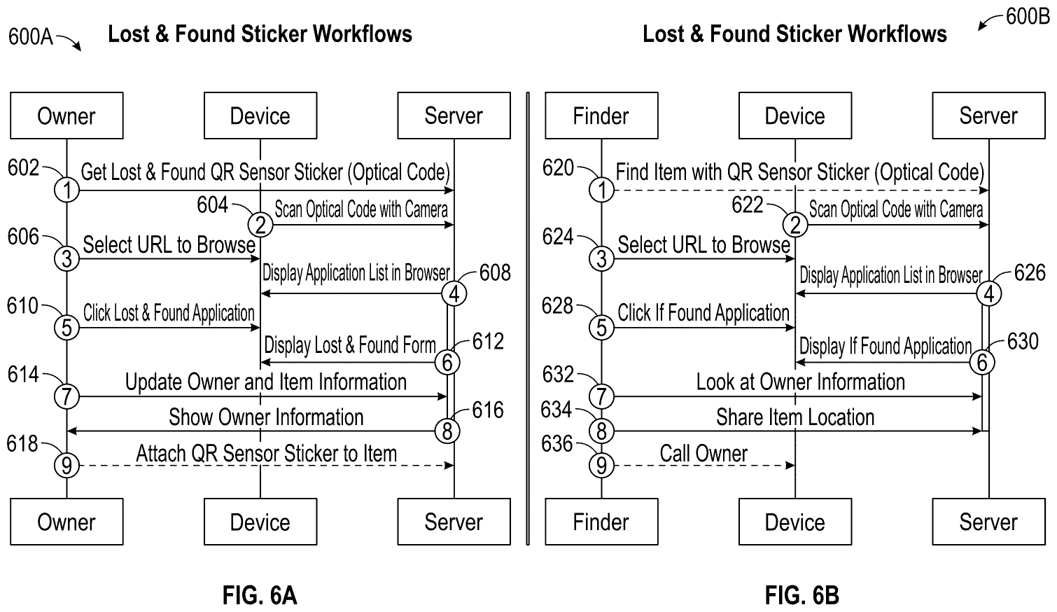

FIG. 6A illustrates an exemplary process 600A for registering a lost and found application associated with an optical code and data repository to an owner of an asset. Process 600A is performed, for example, using one or more electronic devices implementing a software platform. In some examples, process 600A is performed using one or more electronic devices. In some embodiments, process 600A is performed using a client-server system, and the blocks of process 600A are divided up in any manner between the server and one or more client devices. Thus, while portions of process 600A are described herein as being performed by particular devices, it will be appreciated that process 600A is not so limited. In process 600A, some blocks are, optionally, combined, the order of some blocks is, optionally, changed, and some blocks are, optionally, omitted. In some examples, additional steps may be performed in combination with the process 600A. Accordingly, the operations as illustrated (and described in greater detail below) are exemplary by nature and, as such, should not be viewed as limiting.

At block 602, the owner may obtain the optical code (e.g., from a platform associated with the data repository, such as management platform 116). At block 604 the owner may scan the optical code using a device (e.g., cell phone camera). At block 606, the owner may select a resource locator (e.g., URL) displayed at a display of the device upon scanning the optical code. At block 608, a server may return a list of applications in displayed in a browser at the device based on the selected resource locator. At block 610, the owner may select a “lost and found” application by selecting a visual indicator associated with the application displayed at the device. At block 612, based on the selected application, the server may cause the device to display a fillable lost and found form in a browser at the device. At block 614, using the form, the owner may update owner identifying and contact information and/or item information (e.g., a descriptor such as water bottle, car keys, etc.). The owner may provide their name, email, phone number, address, or other information via the form, for instance as shown in the illustrative interface shown in FIG. 7A.

At block 616, the server may receive and display the information provided by the owner in the browser interface. The “owner” can be registered as the owner of the asset by updating keyed values in the data repository associated with the scanned optical code that override access control. For instance, a list of available/allowable emails to access an application could be initially empty, but once a person (e.g., the owner) accesses the application it stores their email address as keyed value, thereafter limiting accessibility of the “lost and found” application to only their identity with accessing the application in the future. There may be special keys for accessing the application (and the corresponding data in the repository), for reading, writing and deleting keys, and so on. These values may override various accessibility settings on a profile associated with a data repository. For example, a truck driver's cell phone could be captured and added as the only person permitted to provide location updates to a data repository associated with an optical code. Only their phone number (as an identity) could access that application (location update). At block 618, the owner may attach the optical code to the asset. One skilled in the art would understand that while FIG. 6B is described with reference to a particular application (a “lost and found” application), the process for registering access privileges (e.g., for accessing an application (and the corresponding data in the repository), for reading, writing and deleting keys, etc.) to an individual is generally applicable to any of the optical code accessible applications described herein.

FIG. 6B illustrates an exemplary process 600B for contacting an owner of an asset (e.g., a lost asset) using an optical code associated with the asset. Process 600B is performed, for example, using one or more electronic devices implementing a software platform. In some examples, process 600B is performed using one or more electronic devices. In some embodiments, process 600B is performed using a client-server system, and the blocks of process 600B are divided up in any manner between the server and one or more client devices. Thus, while portions of process 600B are described herein as being performed by particular devices, it will be appreciated that process 600B is not so limited. In process 600B, some blocks are, optionally, combined, the order of some blocks is, optionally, changed, and some blocks are, optionally, omitted. In some examples, additional steps may be performed in combination with the process 600B. Accordingly, the operations as illustrated (and described in greater detail below) are exemplary by nature and, as such, should not be viewed as limiting.

At block 620, an individual (a “finder”) may find an asset/item with an optical code attached. At block 622, the finder may scan the optical code using an electronic device (e.g., with a cell phone camera). At block 624, the finder may select a resource locator (e.g., URL) displayed at the device upon scanning the optical code. The URL may enable the device to access a server, which may cause the device to display an application list in a browser window at block 626. The list may include an “if found” application associated with the found asset. At block 628, the Finder may select the if found application. At block 630 the server may cause the device to display an interface associated with the if found application (e.g., a single page web application), for instance, as shown in the illustrative interface of FIG. 7B. At block 632 the finder may review the owner information (for instance, the information described above with reference to FIG. 6A) displayed the user interface. At block 634, the finder may select a user affordance to share the location of the found asset using the displayed interface. At block 636, the finder may select a user affordance provided on the user interface to call the owner of the asset.

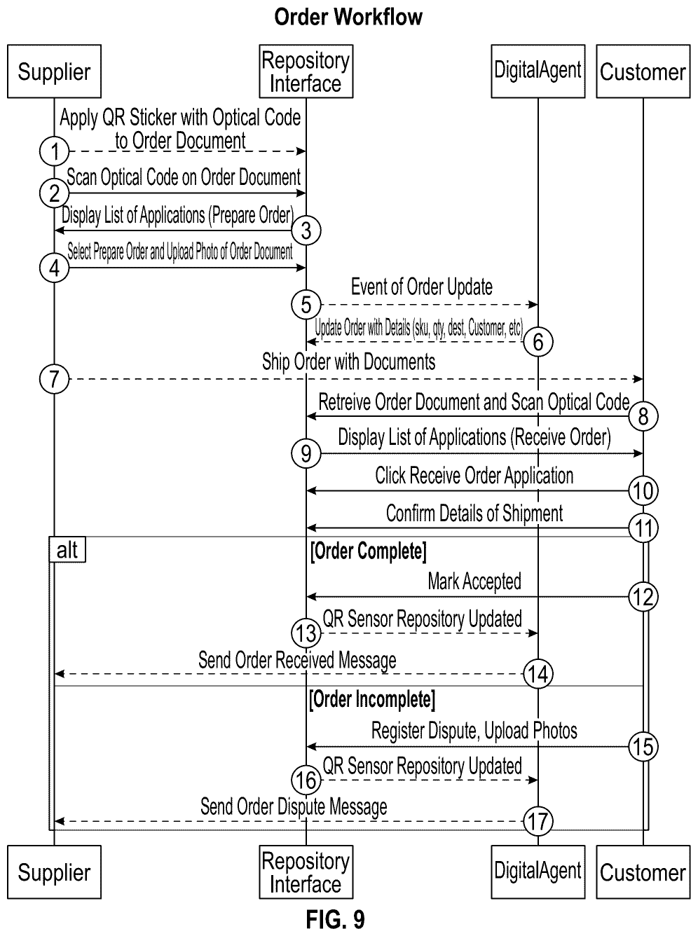

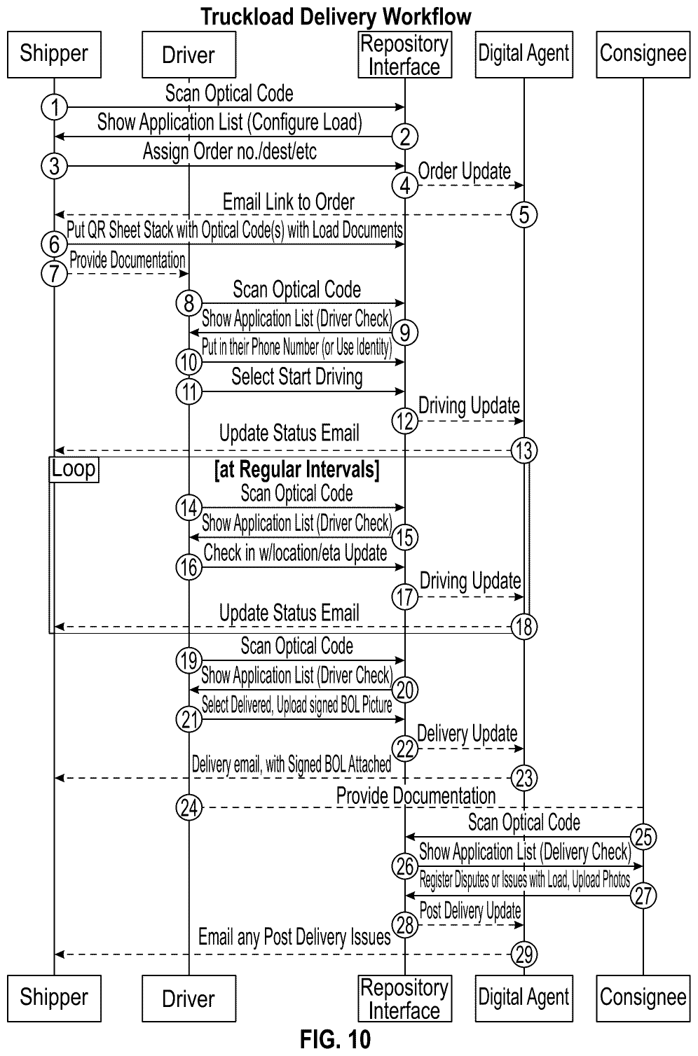

The lost and found example described above is merely one exemplary implementation of the systems and methods described herein. The optical-code enabled data repository interfaces described herein may be utilized for effective collaboration in a variety of supply chain management tasks. FIG. 8 illustrates an exemplary order packing list workflow, FIG. 9 illustrates an exemplary order workflow, and FIG. 10 illustrates an exemplary truckload delivery workflow, steps of which may be performed using the systems and methods described herein.

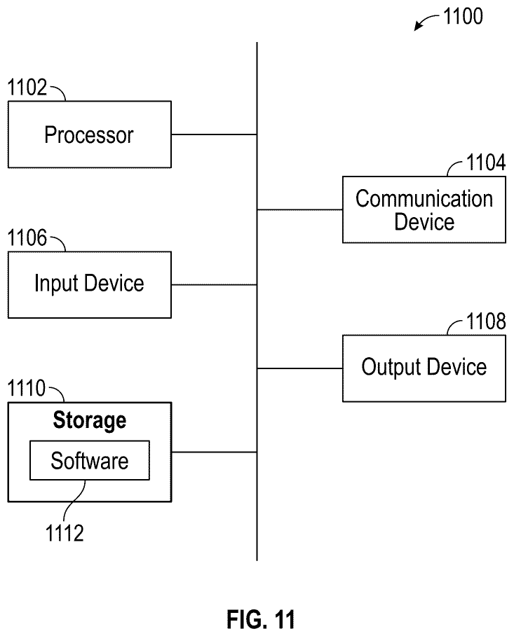

FIG. 11 depicts an exemplary computing device 1100 which may form part of the system 100 described above and may be used for performing various steps of the methods described herein, in accordance with one or more examples of the disclosure. Device 1100 can be a host computer connected to a network. Device 1100 can be a client computer or a server. As shown in FIG. 11, device 1100 can be any suitable type of microprocessor-based device, such as a personal computer, workstation, server, or handheld computing device (i.e., a portable electronic device) such as a phone or tablet. The device can include, for example, one or more of processors 1102, input device 1106, output device 1108, storage 1110, and communication device 1104. Input device 1106 and output device 1108 can generally correspond to those described above and can either be connectable or integrated with the computer.

Input device 1106 can be any suitable device that provides input, such as a touch screen, keyboard or keypad, mouse, or voice-recognition device. Output device 1108 can be any suitable device that provides output, such as a touch screen, haptics device, or speaker.

Storage 1110 can be any suitable device that provides storage, such as an electrical, magnetic, or optical memory, including a RAM, cache, hard drive, or removable storage disk. Communication device 1104 can include any suitable device capable of transmitting and receiving signals over a network, such as a network interface chip or device. The components of the computer can be connected in any suitable manner, such as via a physical bus or wirelessly.

Software 1112, which can be stored in storage 1110 and executed by processor 1102, can include, for example, the programming that embodies the functionality of the present disclosure (e.g., as embodied in the devices as described above). Software 1112 can also be stored and/or transported within any non-transitory computer-readable storage medium for use by, or in connection with, an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1110, that can contain or store programming for use by, or in connection with, an instruction execution system, apparatus, or device. Software 1112 can also be propagated within any transport medium for use by, or in connection with, an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by, or in connection with, an instruction execution system, apparatus, or device. The transport-readable medium can include, but is not limited to, an electronic, magnetic, optical, electromagnetic, or infrared wired or wireless propagation medium.

Device 1100 may be connected to a network, which can be any suitable type of interconnected communication system. The network can implement any suitable communication protocols and can be secured by any suitable security protocols. The network can comprise network links of any suitable arrangement that can implement the transmission and reception of network signals, such as wireless network connections, T1 or T3 lines, cable networks, DSL, or telephone lines. Device 1100 can implement any operating system suitable for operating on the network. Software 1112 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

In some examples of the systems and methods described herein, optical codes may be provided on shipping documents (e.g., Bill of Lading, Commercial Invoice, Packing List) for securely transmitting information to repositories associated with the optical codes and/or sharing information between shipper, consignee, and/or any other entity in the supply chain. The optical code on the document creates a unique document identifier associated with a corresponding repository for data about that document and applications to perform actions around that document. Providing such optical codes on shipping documents, thus uniquely associating the documents with a given data repository (or portion thereof) and/or application(s) may mitigate the problem of forged documentation. Without the optical code and associated applications/repository the parties involved may have no mechanism for verifying that they are interacting with the real document. A document with a unique identifier provides proof that the document received is the document sent through uploading a photo of the document or the data of that document. This ensures that the receiver can verify that the document they signed was the right one, and the product they received was the right product and quantity.

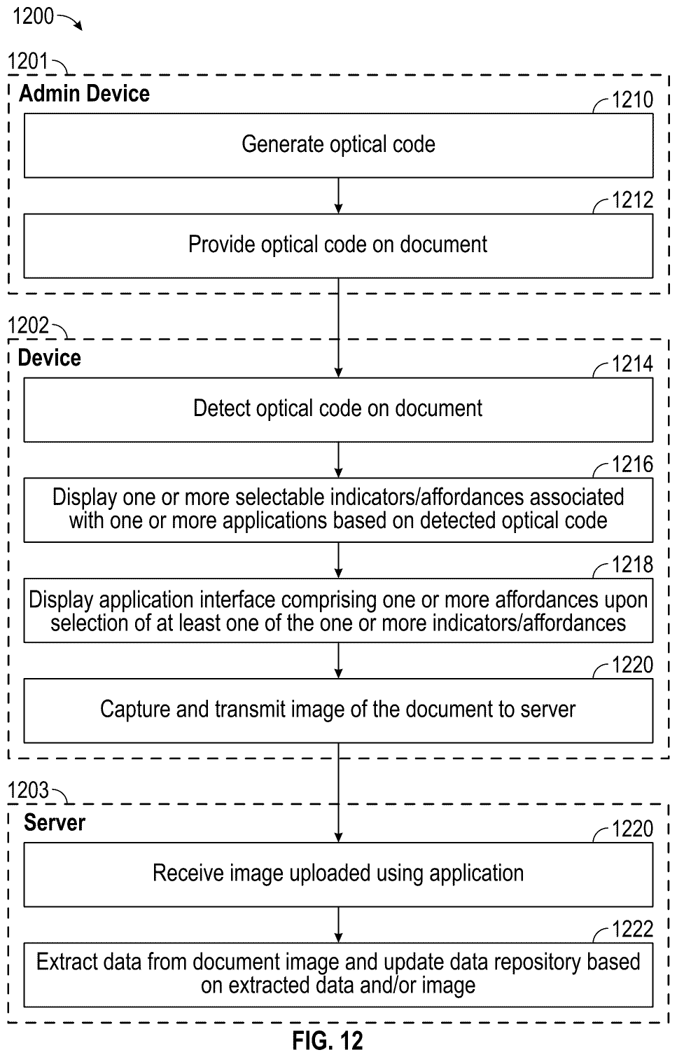

FIG. 12 illustrates a method 1200 for interacting with data repositories associated with optical codes provided on shipping documents, as outlined above, according to some embodiments. Process 1200 is performed, for example, using one or more electronic devices implementing a software platform. In some examples, process 1200 is performed using one or more electronic devices. In some embodiments, process 1200 is performed using a client-server system, and the blocks of process 1200 are divided up in any manner between the server and one or more client devices. Thus, while portions of process 1200 are described herein as being performed by particular devices, it will be appreciated that process 1200 is not so limited. In process 1200, some blocks are, optionally, combined, the order of some blocks is, optionally, changed, and some blocks are, optionally, omitted. In some examples, additional steps may be performed in combination with the process 1200. Accordingly, the operations as illustrated (and described in greater detail below) are exemplary by nature and, as such, should not be viewed as limiting.

At block 1210, admin device 1201 may generate an optical code. The optical code may be generated using a management platform such as management platform 116 described above. The optical code may be generated for an item to be shipped and associated in a data repository with the item to be shipped. At block 1212 the optical code may be provided on a document (e.g., a Bill of Lading, Commercial Invoice, Packing List). The optical code may be printed on the document, may be a sticker attached to the document, and/or may otherwise be established on the document.

At block 1214, device 1202 may detect (e.g., using a camera) the optical code provided on the document associated with the item to be shipped. Device 1202 may be the same device as admin device 1201 or a different device. For instance, a shipper may generate an optical code to be provided on a shipping document as described above, and then may scan the code to interact with one or more applications for adding, deleting, or modifying information in a data repository associated with the shipping document/shipment, as described below.

Upon detecting the optical code, at block 1216, device 1202 may display one or more visual indicators/affordances associated with one or more applications based on the optical code, as described throughout. A user of device 1202 may select at least one of the affordances to open an application associated with the optical code. Upon selection of at least one of the indicators/affordances, at block 1218, device 1202 may display an application interface including one or more affordances. The one or more affordances may include an image capture affordance and/or an image upload affordance. At block 1220, a user may utilize device 1202 to capture an image of the document and upload the image of the document to a server 1203 communicatively coupled with a data repository associated with the optical code. In some examples, the selected application may enable capture and upload of the image with device 1202 within the application. In some examples, the image may be captured using a different application (e.g., a standard camera application on a smartphone), and the image may be uploaded using an affordance of the selected application.

At block 1220, server 1203 receives the image uploaded using the selected application. At block 1222, the server 1203 may apply one or more image processing techniques to extract data from the image of the document and may update the data repository based on the extracted data and/or the image. For example, the server 1203 may utilize one or more machine learning models trained to extract text data from the image of the document and store the text data in relevant portions of the data repository associated with the optical code. The extracted data may include, for instance, an origin address and destination address for a shipment associated with the optical code provided on the document, a carrier identifier for a shipment associated with the optical code provided on the document, an order number for a shipment associated with the optical code provided on the document, a weight of a shipment associated with the optical code provided on the document, a quantity of items for a shipment associated with the optical code provided on the document, a date for a shipment associated with the optical code provided on the document, an authorizing signature for a shipment associated with the optical code provided on the document, or any other information included on a document associated with the shipment. In some embodiments, the data stored in the data repository may be accessible (e.g., via API Keys) and/or automatically transmitted (e.g., using webhooks) to authorized parties connected to the data repository. In some embodiments, each time an authorized user interacts with the data in the data repository, a digital agent may push data to the systems of one or more entities (shippers, customers, carriers, etc.) communicatively coupled to the repository via API keys and/or webhooks.

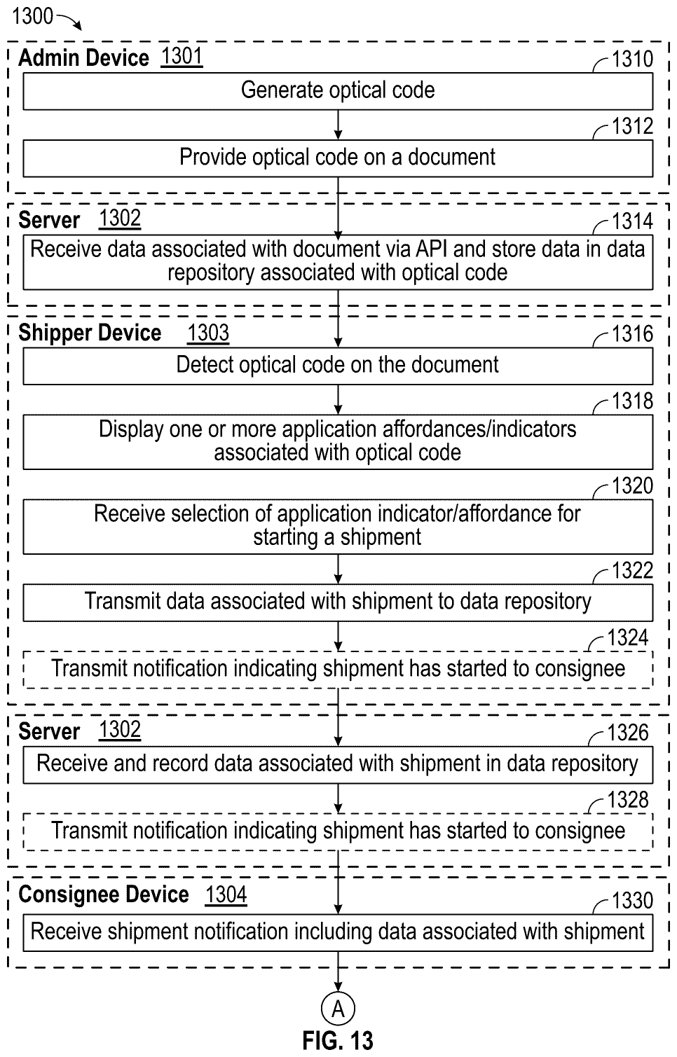

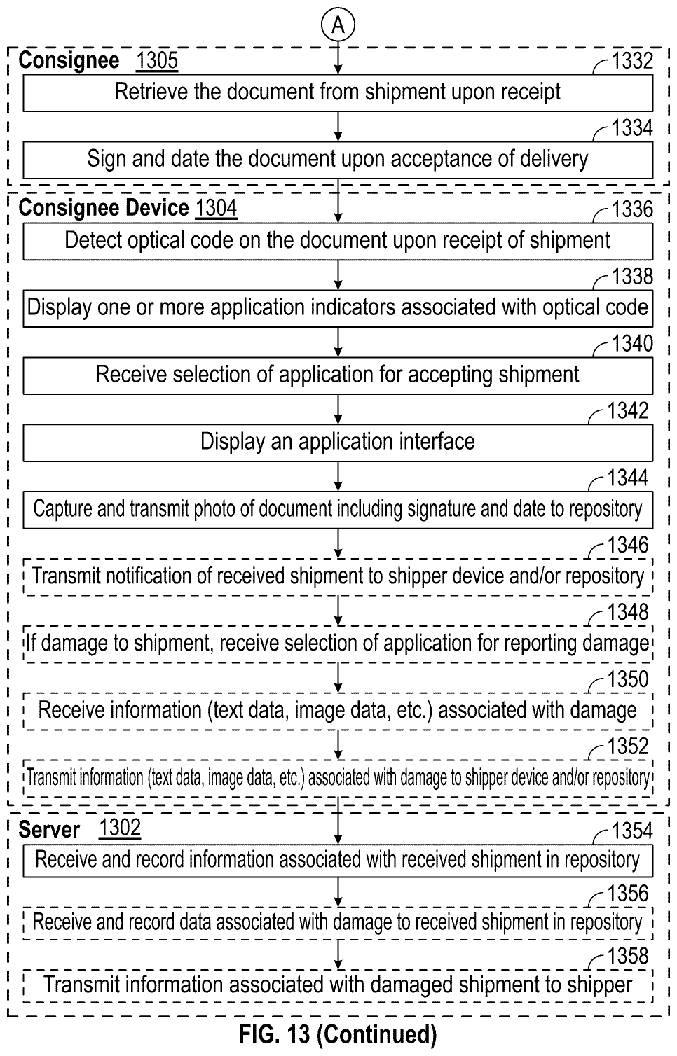

FIG. 13 illustrates an exemplary method 1300 for interacting with a data repository associated with a shipment via applications associated with an optical code provided on a document associated with the shipment. Process 1300 is performed, for example, using one or more electronic devices implementing a software platform. In some examples, process 1300 is performed using one or more electronic devices. In some embodiments, process 1300 is performed using a client-server system, and the blocks of process 1300 are divided up in any manner between the server and one or more client devices. Thus, while portions of process 1300 are described herein as being performed by particular devices, it will be appreciated that process 1300 is not so limited. In process 1300, some blocks are, optionally, combined, the order of some blocks is, optionally, changed, and some blocks are, optionally, omitted. In some examples, additional steps may be performed in combination with the process 1300. Accordingly, the operations as illustrated (and described in greater detail below) are exemplary by nature and, as such, should not be viewed as limiting.

At block 1310, admin device 1301 may generate an optical code. The optical code may be generated using a management platform such as management platform 116 described above. The optical code may be generated for item(s) to be shipped and associated in a date repository with the item(s) to be shipped. At block 1312 the optical code may be provided on a shipping document (e.g., a Bill of Lading, Commercial Invoice, Packing List) to be provided with a shipment. The optical code may be printed on the document, may be a sticker attached to the document, and/or may otherwise be established on the document. Server 1302 may receive data associated with the document via an API at block 1314 and the server 1302 may store the received data in a data repository associated with the optical code. Data stored in the data repository at block 1314 may further be transmitted to other parties (for instance, other parties in the supply chain including the manufacturer, carrier, distribution center, customer, etc.) connected to server 1302 authorized to access data in the data repository.

At block 1316, shipper device 1303 may detect the optical code provided on the document associated with the item(s) to be shipped. Upon detecting the optical code, at block 1318, shipper device 1303 may display one or more visual indicators/affordances associated with one or more applications based on the optical code, as described throughout. A user of device 1303 may select at least one of the affordances to open an application associated with the optical code. In some embodiments, device 1303 may detect selection of an application for starting a shipment at block 1320. At block 1322, shipper device 1303 may transmit data associated with the shipment to a data repository associated with the optical based on selection of the application and/or one or more user affordances provided on an interface of the application. The data may include an image of the document with the optical code, a shipment date and/or time, a shipper identifier, a carrier identifier, an estimated arrival time, etc. At block 1324, shipper device 1303 may optionally transmit a notification (e.g., email) indicating that a shipment has been started to a device of a consignee (e.g., consignee device 1304) of the shipment. The notification may additionally or alternatively be transmitted to other parties in the supply chain including the manufacturer, carrier, distribution center, etc.

At block 1326, server 1302 may receive and store the data associated with the shipment transmitted at block 1322 in the data repository associated with the optical code. The transmitted data associated with the shipment may include, for instance a date and/or time of shipment (e.g., corresponding to the date/time the application for starting the shipment was selected at block 1320). As noted, the data may include an image of the document and the server 1302 may apply one or more image processing techniques to extract data (e.g., text data) from the image. The server 1302 may store the extracted data in the data repository associated with the optical code. At block 1328, the server 1302 optionally transmits a notification (e.g., email) indicating the shipment has started and/or transmits the data stored in the data repository associated with the shipment to consignee device 1304. The server 1302 may optionally transmit the notification indicating the shipment has started and/or the data stored in the data repository associated with the shipment to other parties in the supply chain including the manufacturer, carrier, distribution center, etc.

At block 1330, consignee device 1304 may receive the shipment notification indicating the shipment has started and optionally including other data (e.g., estimated arrival, carrier, weight, quantity, and so on) associated with shipment. At block 1332, a consignee 1305 may obtain the document from the shipment (e.g., remove the document from inside a package, envelope, etc.). At block 1334, consignee 1305 may sign and date the document upon acceptance of the delivery.

At block 1336, upon receipt of the shipment, a consignee (e.g., consignee 1305) may use consignee device 1304 to detect the optical code on the shipping document provided with the shipment. Upon detecting the optical code, at block 1338 consignee device 1304 may display one or more visual indicators/affordances associated with one or more applications based on the optical code, as described throughout. A user of device 1304 may select at least one of the affordances to open an application associated with the optical code. At block 1340, consignee device 1304 may receive a selection of an application for accepting a shipment. Upon receipt of the selection of the application for accepting a shipment, consignee device 1304 may display an application interface at block 1342. The application interface may include one or more affordances and/or a prompt requesting the user upload photo of the document. The one or more affordances may include an image capture affordance and/or an image upload affordance. At block 1344, the user may utilize the device 1304 to capture an image of the document including the signature and date and upload the image of the document including the signature and date to the data repository via server 1302. The shipper device 1303 may be notified (e.g., via API key and/or webhook) of the accepted delivery based on the uploaded photo. In some examples, the selected application may enable capture and upload of the image with device 1304 within the application. In some examples, the image may be captured using a different application (e.g., a standard camera application on a smartphone), and the image may be uploaded using an affordance of the selected application.

At block 1346, consignee device 1304 may optionally transmit a notification of the received shipment the shipper device 1303 and/or the data repository via server 1302. At block 1348, if the shipment is damaged, faulty, etc., a user of device 1304 may select an application affordance of the one or more visual indicators/affordances associated with one or more applications displayed on device 1304 based on the detected optical code for reporting a damaged shipment. At block 1350, the consignee device 1304 may receive information (text data, image data, etc.) associated with damage to the shipment. For instance, a user may use device 1304 to capture an image of the damaged shipment using the application as described above. At block 1352, consignee device 1304 may transmit the information (text data, image data, etc.) associated with the damaged shipment to shipper device 1303 and/or the data repository via server 1302. At block 1354, server 1302 may receive and store the information associated with the received shipment from consignee device 1304 to the data repository. Server 1302 may also optionally receive and store data associated with damage to received shipment in repository at block 1356 and may transmit information associated with the received and/or damaged shipment to shipper device 1302 at block 1358.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for updating a data repository stored at a remote server using one or more applications associated with an optical code, the method comprising:
detecting the optical code by a device comprising an optical detector and a display;
decoding one or more identifying values encoded in the optical code and transmitting information including the one or more identifying values to the remote server;
receiving data indicating the one or more applications from the remote server based on the one or more identifying values;
displaying a visual indicator of the one or more applications at the display of the device based on the received data, wherein the one or more applications are respectively configured to enable access to one or more portions of the data repository based on respective permissions of the one or more applications within the data repository;
detecting a user selection of a visual indicator of the one or more visual indicators associated with an application of the one or more applications;
displaying a user interface associated with the application based on the user selection, wherein the user interface comprises a prompt for a user input for updating one or more keyed values in the data repository;
receiving one or more inputs comprising information associated with the one or more keyed values to be updated via the user interface; and
transmitting information based on the one or more inputs to the remote server, wherein the information comprises an instruction instructing the remote server to update one or more keyed values in the data repository based on the one or more inputs.

2. The method of claim 1, wherein the information transmitted to the server comprises identifying information associated with a user of the device, and wherein the received data indicating the one or more applications from the remote server is obtained by the remote server based on the identifying information associated with the user of the device.

3. The method of claim 2, wherein the identifying information associated with the user of the device comprises a browser cookie.

4. The method claim 1, wherein the respective permissions of the one or more applications are based on a respective position of the one or more applications within a hierarchy of the data repository.

5. The method of claim 1, wherein the prompt comprises a request for an identifier from a user of the device, and wherein access to the application is restricted to one or more identifiers stored in association with the application in the data repository.

6. The method of claim 5, comprising:
receiving the identifier via the user interface in response to the prompt;
transmitting the identifier to the remote server;
comparing the identifier to the one or more identifiers stored in association with the application in the data repository; and
determining whether to enable access to the application based on the comparison.

7. The method of claim 6, wherein the one or more identifiers comprise a domain name, a device identifier, a phone number, an email address, a name, or any combination thereof.

8. The method of claim 1, wherein each respective indication of the one or more applications associated in the data repository with the optical code is displayed in accordance with a determination that a predefined keyed value associated with the respective application of the one or more applications is stored in the data repository.

9. The method of claim 1, wherein the selected application is configured to enable registration of the optical code in the data repository with a unique identifier, and wherein the registration of the optical code in the data repository with the unique identifier restricts access to the application associated with the optical code to one or more users associated with the unique identifier.

10. The method of claim 9, wherein the one or more inputs comprise the unique identifier and wherein the instruction instructs the remote server to register the optical code associated with the application in the data repository with the unique identifier by associating the unique identifier with the optical code in the data repository.

11. The method of claim 1, wherein the one or more keyed values comprise: an event associated with an asset, an image of the asset, a measured characteristic of the asset, a handling instruction associated with the asset, an individual associated with the asset, a location of the asset, or any combination thereof.

12. The method of claim 1, wherein updating the one or more keyed values comprises: adding a keyed value to the data repository, deleting a keyed value from the data repository, modifying a keyed value in the data repository, or any combination thereof.

13. The method of claim 1, further comprising: transmitting, by the remote server, a notification to an external service based on the update to the one or more keyed values in the data repository, wherein the notification is transmitted to a URL associated with the external service stored in the data repository.

14. The method of claim 1, wherein the data repository is configured to enable one or more external services to read, write, and delete data stored in the one or more portions of the data repository using one or more application programming interface (API) keys.

15. The method of claim 1, wherein the device is a mobile phone.

16. A system for updating a data repository stored at a remote server using one or more applications associated with an optical code, the system comprising: one or more processors and memory storing one or more computer programs that include computer instructions, which when executed by the one or more processors, cause the system to:
decode one or more identifying values encoded in the optical code detected by a device comprising an optical detector and a display;
transmit information including the one or more identifying values to the remote server;
receive data indicating the one or more applications from the remote server based on the one or more identifying values;
cause display of a visual indicator of the one or more applications at the display of the device based on the received data, wherein the one or more applications are respectively configured to enable access to one or more portions of the data repository based on respective permissions of the one or more applications within the data repository;
detect a user selection of a visual indicator of the one or more visual indicators associated with an application of the one or more applications;
cause display of a user interface associated with the application based on the user selection, wherein the user interface comprises a prompt for a user input for updating one or more keyed values in the data repository;
receive one or more inputs comprising information associated with the one or more keyed values to be updated via the user interface; and
transmit information based on the one or more inputs to the remote server, wherein the information comprises an instruction instructing the remote server to update one or more keyed values in the data repository based on the one or more inputs.

17. A non-transitory computer readable storage medium storing instructions for updating a data repository stored at a remote server using one or more applications associated with an optical code, the instructions configured to be executed by a system, the system comprising one or more processors to cause the system to:
decode one or more identifying values encoded in the optical code detected by a device comprising an optical detector and a display;
transmit information including the one or more identifying values to the remote server;
receive data indicating the one or more applications from the remote server based on the one or more identifying values;
cause display of a visual indicator of the one or more applications at the display of the device based on the received data, wherein the one or more applications are respectively configured to enable access to one or more portions of the data repository based on respective permissions of the one or more applications within the data repository;
detect a user selection of a visual indicator of the one or more visual indicators associated with an application of the one or more applications;
cause display of a user interface associated with the application based on the user selection, wherein the user interface comprises a prompt for a user input for updating one or more keyed values in the data repository;
receive one or more inputs comprising information associated with the one or more keyed values to be updated via the user interface; and
transmit information based on the one or more inputs to the remote server, wherein the information comprises an instruction instructing the remote server to update one or more keyed values in the data repository based on the one or more inputs.

18. A system for updating a data repository using one or more applications associated with an optical code, the system comprising one or more processors and memory storing one or more computer programs that include computer instructions, which when executed by the one or more processors, cause the system to:
at a server:
receive data comprising one or more identifying values decoded from an optical code;
compare the received data to one or more keyed values in the data repository to identify data indicating the one or more applications based on the received data;
transmit the data indicating the one or more applications to a mobile device, wherein the one or more applications are respectively configured to enable access to one or more portions of the data repository based on respective permissions of the one or more applications within the data repository;
receive information based on one or more inputs provided at a user interface of the mobile device, the user interface associated with a selected application of the one or more applications, wherein the information comprises an instruction instructing the server to update one or more keyed values in the data repository based on the one or more inputs; and
update the one or more keyed values in the data repository based on the received information.

19. The system of claim 18, wherein updating the one or more keyed values comprises adding a new keyed value to the data repository as a new version of the updated keyed value and archiving the previous version of the keyed value in the data repository.

20. The system of claim 18, wherein the computer instructions, when executed by the one or more processors, cause the system to: transmit a notification to an external service based on the update to the one or more keyed values in the data repository.

21. The system of claim 18, wherein the notification comprises at least the updated keyed values.

22. A non-transitory computer readable storage medium storing instructions for updating a data repository using one or more applications associated with an optical code, the instructions configured to be executed by a system, the system comprising one or more processors to cause the system to:
at a server:
receive data comprising one or more identifying values decoded from an optical code;
transmit data indicating the one or more applications based on the one or more identifying values to a mobile device, wherein the one or more applications are respectively configured to enable access to one or more portions of the data repository based on respective permissions of the one or more applications within the data repository;
receive information based on one or more inputs provided at a user interface of the mobile device, the user interface associated with a selected application of the one or more applications, wherein the information comprises an instruction instructing the server to update one or more keyed values in the data repository based on the one or more inputs; and
update the one or more keyed values in the data repository based on the received information.
